(19) United States
(12) Patent Application Publication
(10) Pub. No.: US 2015/0213505 A1
(43) Pub. Date: Jul. 30, 2015

(54) SYSTEMS AND METHODS FOR PROVIDING MOBILE APPLICATIONS TO USERS AT A PREDETERMINED DATA RATE

(71) Applicant: LotusFlare, Inc., Fremont, CA (US)

(72) Inventors: Qing Guo, Mountain View, CA (US); Surendra Gadodia, Fremont, CA (US); Shao Yong Xia, Fremont, CA (US)

(73) Assignee: LotusFlare, Inc., Fremont, CA (US)

(21) Appl. No.: 14/684,213

(22) Filed: Apr. 10, 2015

Related U.S. Application Data
(63) Continuation of application No. 14/313,972, filed on Jun. 24, 2014.
(60) Provisional application No. 61/847,260, filed on Jul. 17, 2013.

(51) Int. Cl. G06Q 30/02; H04W 28/02; H04L 12/859; H04L 29/08

(52) U.S. Cl. CPC G06Q 30/0267; H04L 67/10; G06Q 30/0272; H04W 28/0215; H04L 47/2475

(57) ABSTRACT

Systems and methods are described for providing mobile applications at a predetermined data rate. In an embodiment, a request for a campaign is received, the request including an application title, an access endpoint, a campaign duration, and a list of a plurality of communication network operators. In response to receiving the request for the campaign, a special rating request is sent to each communications network operator on the list. The special rating request requests that a predetermined data rate be applied to data associated with the access endpoint for the campaign period. The data associated with the access endpoint is made available at the predetermined data rate on a communications network. Furthermore, advertising may be provided that communicates that the application is available for download and for use on the communications network at the predetermined data rate.

### CROSS-REFERENCE TO RELATED APPLICATIONS

This application is a continuation of U.S. patent application Ser. No. 14/313,972, filed Jun. 24, 2014, entitled “Systems and Methods for Providing Mobile Applications to Users at a Predetermined Data Rate” which claims priority to provisional U.S. patent application No. 61/847,260, filed on Jul. 17, 2013 and entitled “Systems, Devices, and/or Methods for Managing Mobile Applications” which is incorporated herein in its entirety.

### TECHNICAL FIELD

This disclosure relates generally to mobile communications device applications, including, more particularly, to permitting a developer of a mobile application to create and manage campaigns over multiple operators, where data for the mobile application is provided at a predetermined rate to users.

### SUMMARY OF THE INVENTION

Systems and methods are described for providing mobile applications to users at a predetermined data rate. The predetermined data rate may be a zero rate for data that is associated with an application provided by an application developer. A request for a campaign may be received at a server, the request including an application title, an access endpoint (or endpoints), a campaign duration, and a communications network operator list of a plurality of communication network operators. Each communications network operator may provide the application having the application title to end users on a communications network operated by the communications network operator. The campaign period is a period of time for which the campaign is active. In response to receiving the request for the campaign, the server may transmit a special rating request to each communications network operator on the communications network operator list. The special rating request may include a request to apply a predetermined data rate to data associated with the access endpoint for the campaign period specified by the request for the campaign.

The server may then cause the data associated with the access endpoint to be available at the predetermined data rate on the communications network of one of the communications network operators on the communications network operator list. Furthermore, advertising may be provided by the server to at least one of the end users that the application. The advertising may communicate that the application is available for download and for use on the communications network of the one of the communications network operators at the predetermined data rate. Additional embodiments may include geographic location-based zero-rating of the application, analytics that include information regarding data consumption associated with the application during the campaign, and other useful features.

### BRIEF DESCRIPTION OF THE FIGURES

This disclosure is illustrated by way of example and not limitation in the figures of the accompanying drawings, in which like references indicate similar elements, and in which:

FIG. 1 shows a simplified block diagram of a distributed computing network connecting a server and devices in which a system for providing mobile applications to users at a predetermined data rate may be implemented.

FIG. 2 shows a more detailed diagram of a mobile communications device.

FIG. 3 shows a simplified block diagram of a specific embodiment of a system for providing mobile applications to users at a predetermined data rate.

FIG. 4 shows a block diagram of another specific embodiment of a system for providing mobile applications to users at a predetermined data rate.

FIG. 5 shows a embodiment of a flow diagram for providing mobile applications to users at a predetermined data rate.

FIG. 6 is a screenshot illustrating configurable settings according to embodiments of a request for a campaign.

FIG. 7 is a screenshot illustrating configurable settings according to embodiments of an application configuration GUI.

FIG. 8 is a screenshot illustrating configurable settings according to embodiments of an existing campaign.

FIG. 9 is a screenshot illustrating configurable settings according to embodiments of platform application.

### DETAILED DESCRIPTION

Certain exemplary embodiments, may be used to create a channel with improved user experiences for mobile app developers to promote, market, and/or target their apps to consumers using mobile operators' assets (e.g., bandwidth, SMS, and/or user behavior data, etc.). As used herein, the phrase “app” means any application that runs on a mobile device and that utilizes data, such as text, graphics, audio, video, photos, animation, and/or augmented reality. As used herein, the phrase “streaming digital content” means any digital content that can be streamed, including audio (e.g., radio, podcasts, etc.), video, animations, game displays, simulations, augmented reality, etc.

Certain specific embodiments can provide a software platform for any mobile app developer to use mobile operator assets for promoting, marketing, and/or targeting their apps to mobile operators' subscribers so that subscribers do not necessarily have to pay for data while downloading and/or using that app for a set period. For example, a platform may be provided where mobile operators and/or app developers can negotiate prices for data for downloading and/or using of an app and/or stream of digital content by a subscriber. Also, an API may be provided, through the platform, that can simplify the updating of a “zero rating” policy (e.g., where all IP addresses and/or individual streaming digital files included in the policy are excluded and/or immune from data charges) in an operator's gateway. The platform can allow an app developer to promote their apps by targeting users based on region and/or demographics, etc. The platform can also automatically set up the apps for special rating with the appropriate operators. Apps may be targeted, ranked, and/or recommended using the platform based on the user's app usage and/or engagement patterns.

Furthermore, the platform can allow operators to offer data packages through an app via notifications to engaged subscribers. A mechanism may be offered using the platform for app developers to offer and/or provide special rate apps for subscribers who are roaming outside of their home network. Another mechanism may be offered by the platform for operators to offer data packages at special rate to subscribers for a set of apps while roaming outside of their home network. Lastly, the platform can provide an analytical framework that can provide one or more rich insights based on data collected by the platform, subscribers, operators, and/or developers.

Users of mobile devices (e.g., cellular-connectable smartphones, tablets, laptops, etc.) with no or limited data plans are often reluctant to download and/or use an app because they are worried about getting charged and/or overcharged for the data. These users sometimes wait for WiFi access before downloading and/or using an app. However, this delay can defeat the very essence of the utility of a mobile device. Providing a platform where app developers can subsidize data costs can incentivize such users to download and/or use these apps irrespective of whether they are in a WiFi accessible zone or not.

A potential problem facing app developers is finding a cost effective marketing channel to acquire new users to download and/or stay engaged with their apps. The traditional marketing channels, including search engines, app stores, and/or interstitial impressions, often are not cost effective because, e.g., developers pay for impressions without acquiring new users and/or acquired users do not stay engaged because of, e.g., friction of cost of data. Zero rating can increase the incentive to install and/or continue to use a zero rated app over a non-zero rated app that has similar attributes. Zero rating of streaming digital content can increase the incentive to use a zero rated app and/or increase viewership of zero rated content. An app developer often cannot scalably work with hundreds of the mobile operators around the world and/or a mobile operator often cannot scalably work with the tens of thousands of app developers. However, via certain specific embodiments, developers can pay only for the data required for downloads and/or engagement with their apps.

Another potential problem for mobile operators is finding new revenue streams in the mobile app marketplace. Some operators charge app developers to pre-install apps on mobile handsets, but this can be expensive and/or ineffective because, e.g., it is not necessarily targeted and/or does not necessarily create a good user experience. Mobile operators can have the ability to special rate an app without charging users by whitelisting IP addresses of those apps, but this process typically is not scalable. Certain specific embodiments can make whitelisting of IP addresses for special rating simple and/or scalable and/or provide an effective way for developers to target their apps to specific user segments based on, e.g., mobile operator demographic data. Additionally, potential problem for mobile device users who connect to roaming networks can be the high costs of roaming data traffic.

Certain specific embodiments can provide different ways of providing data to users at a predetermined special rate. One such way may be roaming prepay, where operators may offer data packages at special rates for a set of apps for subscribers who are roaming outside of their home network. Another way may be roaming paid by app developers, where app developers target and/or incentivize roaming users to use their apps by providing predetermined special rating roaming data. A third specific embodiment may be setting up zero rating, as described herein.

Certain specific embodiments can solve one or more of these problems by bringing developers and mobile operators onto a single platform with self-service APIs. Traditional marketing channels often compete for the limited time that users spend engaging with mobile apps. The incentive provided by free data can enable certain specific embodiments to increase the time that users spend engaging with mobile apps and/or viewing certain content, which can benefit app developers, content producers, and/or mobile operators. Certain specific embodiments can connect mobile operator, app developer, and/or users together to offer a compelling marketing platform that potentially benefits all three parties. It can provide a simple configuration and/or setup process for zero rating many apps and/or streaming digital content at any given time. Via certain specific embodiments, users on limited or no data plans can engage with promoted apps and/or promoted streaming content anywhere and/or without concern for data costs. Typically, users do not have this option unless their operator provided usage plans for certain apps at prepaid costs. Via the described specific embodiments, app developers need not be burdened with negotiation and/or configuration challenges with many mobile operators. A scalable platform may be provided where this communication can be standardized and/or setup can be simple and/or convenient across all mobile operators in the network. Via certain specific embodiments, operators do not necessarily need to deal with many app developers that have different resource constraints. Instead, the opportunity for mobile operators may provide zero rating to many app developers continuously due to the simplified setup and/or configuration process.

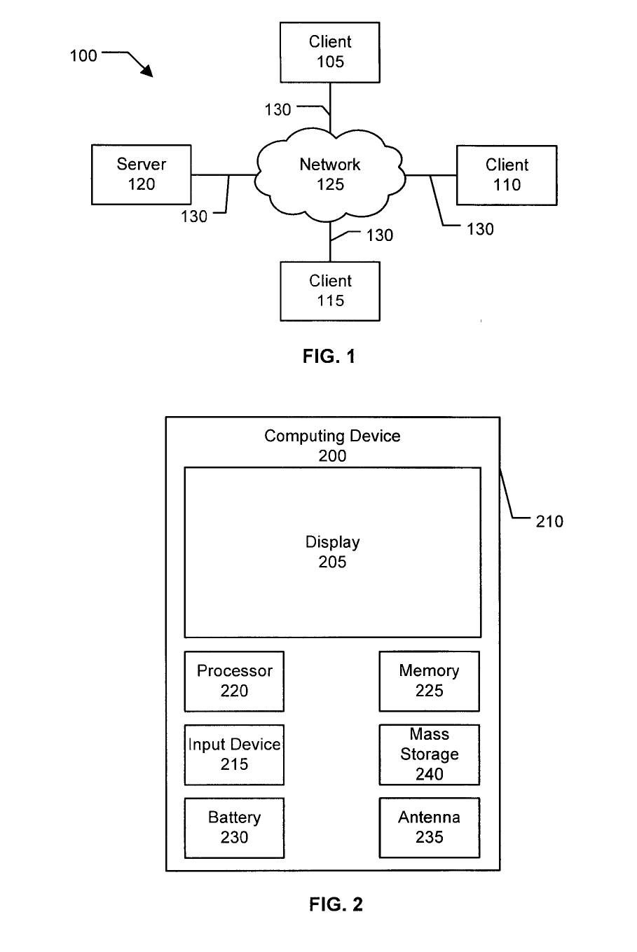

FIG. 1 is a simplified block diagram of a distributed computer network 100 incorporating a specific embodiment of the present invention. Computer network 100 includes a number of mobile client systems 105, 110, and 115, and a server system 120 coupled to a communication network 125 via a plurality of communication links 130. Communication network 125 provides a mechanism for allowing the various components of distributed network 100 to communicate and exchange information with each other.

Communication network 125 may itself be comprised of many interconnected computer systems and communication links. Communication links 130 may be hardwire links, optical links, satellite or other wireless communications links, wave propagation links, or any other mechanisms for communication of information. Various communication protocols may be used to facilitate communication between the various systems shown in FIG. 1. These communication protocols may include TCP/IP, HTTP protocols, wireless application protocol (WAP), vendor-specific protocols, customized protocols, and others. While in one embodiment, communication network 125 is the Internet, in other embodiments, communication network 125 may be any suitable communication network including a local area network (LAN), a wide area network (WAN), a wireless network, an intranet, a private network, a public network, a switched network, and combinations of these, and the like.

Distributed computer network 100 in FIG. 1 is merely illustrative of a specific embodiment incorporating the present invention and is not intended to limit the scope of the invention as recited in the claims. One of ordinary skill in the art would recognize other variations, modifications, and alternatives. For example, more than one server system 120 may be connected to communication network 125. As another example, a number of mobile client systems 105, 110, and 115 may be coupled to communication network 125 via an access provider (not shown) or via some other server system.

Mobile client systems 105, 110, and 115 typically request information from a server system which provides the information. It should be appreciated, however, that information can generally flow in both directions (e.g., a backup service primarily sends data from clients to server), but the server is the service provider. Server systems by definition typically have more computing and storage capacity than mobile client systems. However, a particular computer system may act as both a client or a server depending on whether the computer system is requesting or providing information. Aspects of the invention may be embodied using a client-server environment or a cloud-cloud computing environment.

Server 120 is responsible for receiving information requests from mobile client systems 105, 110, and 115, performing processing required to satisfy the requests, and for forwarding the results corresponding to the requests back to the requesting mobile client system. The processing required to satisfy the request may be performed by server system 120 or may alternatively be delegated to other servers connected to communication network 125.

Mobile client systems 105, 110, and 115 enable users to access and query information or applications stored by server system 120. A mobile client may be referred to as a distributed mobile client. Some example mobile client systems include but are not limited to portable electronic devices (e.g., mobile communication devices) whose principle function is voice communication including the Apple iPhone®, the Apple iPad®, the Palm Pre™, or any mobile device running the Apple iOS™, Android™ OS, Google Chrome OS, Symbian OS®, Windows Mobile® OS, Palm OS® or Palm Web OS™. In a specific embodiment, a “web browser” application executing on a mobile client system enables users to select, access, retrieve, or query information and/or applications stored by server system 120. Examples of web browsers include the Android browser provided by Google, the Safari® browser provided by Apple, the Opera Web browser provided by Opera Software, the BlackBerry® browser provided by Research In Motion, the Internet Explorer® and Internet Explorer Mobile browsers provided by Microsoft Corporation, the Firefox® and Firefox for Mobile browsers provided by Mozilla®, and others.

FIG. 2 shows a specific embodiment of a computer system such as a mobile client system of the present invention. In an embodiment, a user interfaces with the system through a client system, such as shown in FIG. 2. Mobile client communication or portable electronic device 200 includes a display, screen, or monitor 205, housing 210, and input device 215. Housing 210 may house familiar computer components, some of which are not shown, such as a processor 220, memory 225, battery 230, speaker, transceiver, antenna 235, microphone, ports, jacks, connectors, camera, input/output (I/O) controller, display adapter, network interface, mass storage devices 240, and the like and various combinations thereof. These components may be connected using any interconnection scheme or bus architecture.

Input device 215 may also include a touchscreen (e.g., resistive, surface acoustic wave, capacitive sensing, infrared, optical imaging, dispersive signal, or acoustic pulse recognition), keyboard (e.g., electronic keyboard or physical keyboard), buttons, switches, stylus, or a combination of these.

Mass storage devices 240 may include flash and other nonvolatile solid-state storage or solid-state drive (SSD), such as a flash drive, flash memory, or USB flash drive. Other examples of mass storage include mass disk drives, floppy disks, magnetic disks, optical disks, magneto-optical disks, fixed disks, hard disks, CD-ROMs, recordable CDs, DVDs, recordable DVDs (e.g., DVD-R, DVD+R, DVD-RW, DVD+RW, HD-DVD, or Blu-ray Disc), battery-backed-up volatile memory, tape storage, reader, and other similar media, and combinations of these.

The invention may also be used with computer systems having different configurations, e.g., with additional or fewer subsystems. For example, a computer system could include more than one processor (i.e., a multiprocessor system, which may permit parallel processing of information) or a system may include a cache. The computer system shown in FIG. 2 is but an example of a computer system suitable for use with the present invention. Other configurations of subsystems suitable for use with the present invention will be readily apparent to one of ordinary skill in the art.

For example, in a specific implementation, the computing device is a mobile communication device such as a smartphone or tablet computer. Some specific examples of smartphones include the Droid Incredible and Google Nexus One, provided by HTC Corporation, the iPhone or iPad, both provided by Apple, and many others. Typically, these mobile or portable computing devices have less resources (e.g., memory, storage, smaller screens, or processing power) than a desktop computer. Further, such mobile or portable computing devices are designed to be powered primarily by a battery, rather than being constantly plugged in to a power outlet as in the case of a desktop computer. So, given these differences between portable and non-portable computing devices, it is generally desirable that applications on portable computing devices be small and lightweight (e.g., consume relatively fewer resources as compared to non-portable computing devices). The computing device may be a laptop or a netbook. In another specific implementation, the computing device is a non-portable computing device such as a desktop computer or workstation.

A computer-implemented or computer-executable version of the program instructions useful to practice the present invention may be embodied using, stored on, or associated with non-transitory computer-readable medium. Non-transitory computer-readable medium may include any medium that participates in providing instructions to one or more processors for execution. Such a medium may take many forms including, but not limited to, nonvolatile, volatile, and transmission media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media can also take the form of electromagnetic, radio frequency, acoustic, or light waves, such as those generated during radio wave and infrared data communications.

For example, a binary, machine-executable version, of the software useful to practice the present invention may be stored or reside in RAM or cache memory, or on mass storage device 240. The source code of this software may also be stored or reside on mass storage device 240 (e.g., flash drive, hard disk, magnetic disk, tape, or CD-ROM). As a further example, code useful for practicing the invention may be transmitted via wires, radio waves, or through a network such as the Internet. In another specific embodiment, a computer program product including a variety of software program code to implement features of the invention is provided.

Computer software products may be written in any of various suitable programming languages, such as C, C++, C#, Pascal, Fortran, Perl, Matlab (from MathWorks, www.mathworks.com), SAS, SPSS, JavaScript, CoffeeScript, Objective-C, Objective-J, Ruby, Python, Erlang, Lisp, Scala, Clojure, and Java. The computer software product may be an independent application with data input and data display modules. Alternatively, the computer software products may be classes that may be instantiated as distributed objects. The computer software products may also be component software such as Java Beans (from Oracle) or Enterprise Java Beans (EJB from Oracle).

An operating system for the system may be the Android operating system, iPhone OS (i.e., iOS), Symbian, BlackBerry OS, Palm web OS, bada, MeeGo, Maemo, Limo, or Brew OS. Other examples of operating systems include one of the Microsoft Windows family of operating systems (e.g., Windows 95, 98, Me, Windows NT, Windows 2000, Windows XP, Windows XP x64 Edition, Windows Vista, Windows 7, Windows CE, Windows Mobile, Windows Phone 7), Linux, HP-UX, UNIX, Sun OS, Solaris, Mac OS X, Alpha OS, AIX, IRIX32, or IRIX64. Other operating systems may be used.

Furthermore, the mobile device or portable computer device may be connected to a network and may interface to other computers using this network. The network may be an intranet, internet, or the Internet, among others. The network may be a wired network (e.g., using copper), telephone network, packet network, an optical network (e.g., using optical fiber), mobile network, or a wireless network, or any combination of these. For example, data and other information may be passed between the mobile device or portable computer and components (or steps) of a system useful in practicing the invention using a mobile network employing a protocol such as code division multiple access (CDMA), Global System for Mobile Communications/General packet radio service (GSM)/(GPRS), Worldwide Interoperability for Microwave Access (WiMAX), or 3GPP Long Term Evolution (LTE) or a wireless network employing a protocol such as Wi-Fi (IEEE standards 802.11, 802.11a, 802.11b, 802.11e, 802.11g, 802.11i, and 802.11n, just to name a few examples). For example, signals from a computer may be transferred, at least in part, wirelessly to components or other computers, or from mobile communications devices to other mobile communications devices.

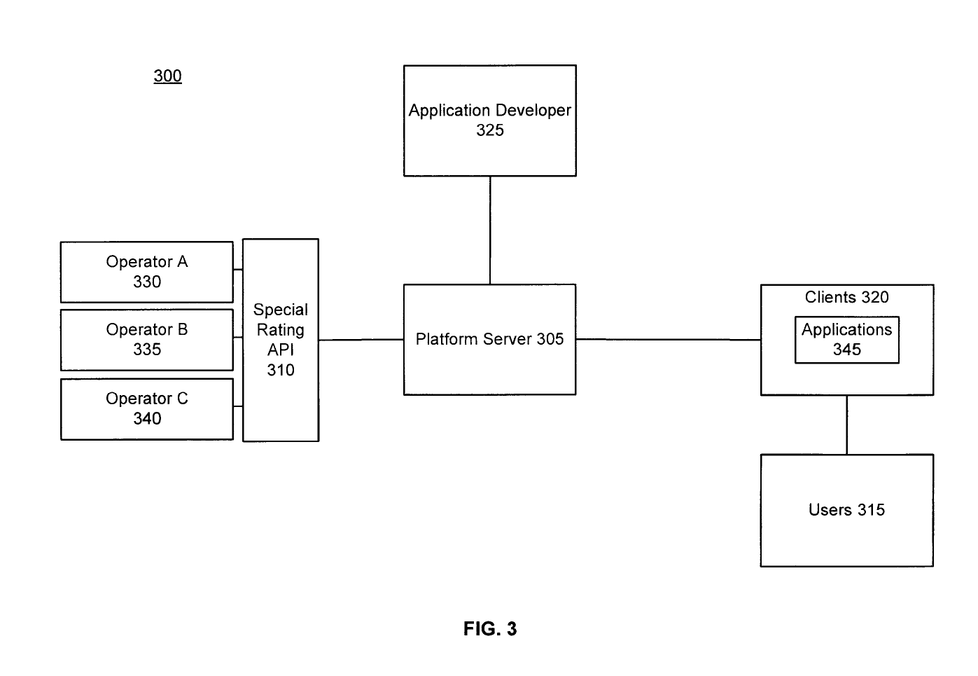

FIG. 3 shows a simplified block diagram of a specific embodiment of a system 300 for providing mobile applications to users at a predetermined data rate. System 300 may include platform server 305, clients 320, application developer 325, and exemplary operators A 325, B 335, and C 340. The clients 320, platform server 305, application developer 325 and the operators may be communicatively coupled to each other via a network.

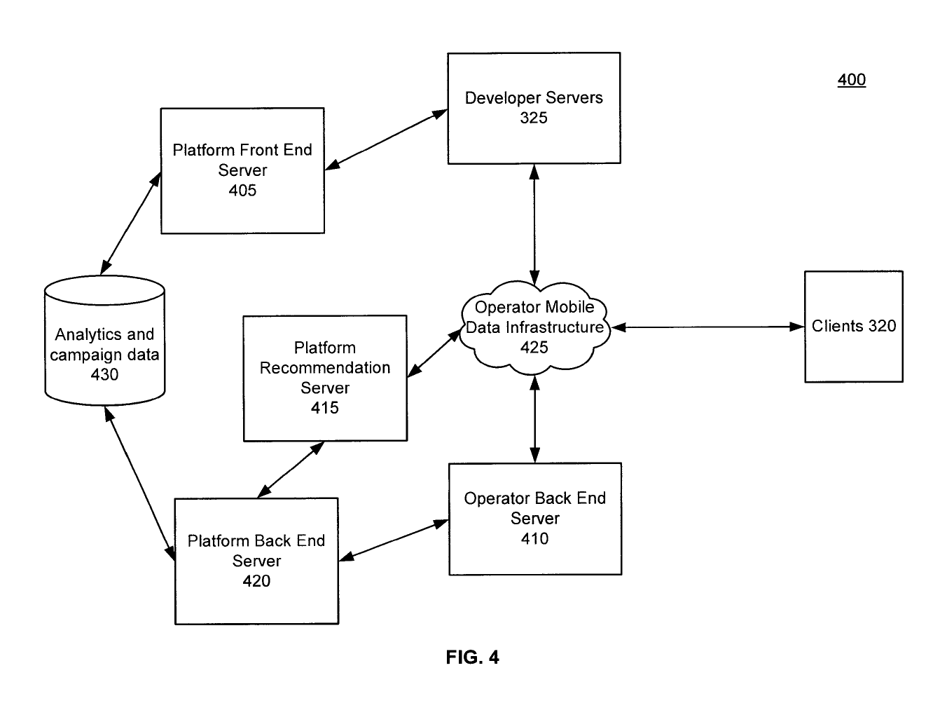

Via the platform server 305, essentially any app developer 325 can partner with essentially any mobile operator, thereby allowing developers to acquire and/or engage with users in a scalable and/or cost effective way. Platform server 305 may be used to implement methods of providing data associated with mobile applications to users at a predetermined rate, such as, for example, the method described with reference to FIG. 4 below.

Users 315 may interact with their client mobile devices 320 via application programs 345 on the devices. An application program may be referred to as an “app.” Such applications are developed or provided by application developers 325 or content providers. These applications are typically made available for the clients 320 via a marketplace such as the Android Market and Apple App Store.

Operator A 330, Operator B 335, and Operator C 340 may be operators of mobile telecommunications networks that provide wireless communication services to a plurality of clients 320. Examples of mobile operators include Verizon Communications Inc. of New York, N.Y. and AT & T of Dallas, Tex. In an embodiment, Operator A 330, Operator B 335, and Operator C 340 may each communicate with platform server 305 via special rating API 310, which may be used to provide mobile applications to users at a predetermined data rate as described below.

FIG. 4 shows a block diagram of another specific embodiment of a system 400 for providing mobile applications to users at a predetermined data rate. System 400 may include clients 320 and application developer servers 325. System 400 may also include platform front end server 405, platform recommendation server 415 and platform back end server 420. In some embodiments, platform server 305 from FIG. 3 may include multiple servers, and may include each of platform front end server 405, platform recommendation server 415 and platform back end server 420.

Developers 325 may configure application campaign settings via a developer portal provided by platform front end server 405. Such campaign settings may include defining campaign target users and the app settings for the predetermined data rate. The developer portal can provide a front end web site for app developers 325 to log in and/or provide a description of their app. Developers 325 can provide URI end points and/or one or more URIs to digital content that their apps can access when zero rating. Developers 325 can specify target locations and/or demographics to promote their app to and/or a time period for promotion.

The developer-provided campaign settings may be received by the platform front end server 405 in a request for a campaign. The platform front end server 405 may store the campaign settings on campaign database 430, which may then be accessed by platform backend server 420. Platform back end server 420 may forward the campaign settings to mobile operator back end server 410 using a special rating request. The platform back end server 420 may also add the app that is the subject of the request for the campaign to the platform recommendation server 415, which may advertise that the app is available at a predetermined data rate to clients 320 via operator mobile data infrastructure 425.

The platform back end server 420 can provide developers 325 with statistics on their app installation and/or usage. The platform back end server 420 may serve as a hub for connections between the developer portal provided by platform front end server 405 and the mobile operator in some embodiments. Furthermore, the platform back end server 420 may track app install and engagement, and track promotion time period for every app for which there is an active campaign. In communicating with a mobile operator (e.g., via operator back end server 410), platform back end server 420 may update a mobile operator on what URI end points to zero rate for apps and/or digital video content that are promoted, update a mobile operator on what URI end points to remove zero rating for apps and/or digital video content that have ended promotion time period, collect logging information on usage from the recommendation app and/or the mobile operator. During the campaign serviced by the platform, platform back end server 420 may provide developer portal statistics on app promotion effectiveness, such as number of downloads, time spent on apps, content streamed, demographics of people using apps, etc, and/or manage and arbitrate billing disputes between developer 325 and the mobile operator.

Operator back end server 410 may provide data related to the app to be available to clients 320 at the predetermined data rate in response to the special rating request. This may be done, for example, by providing data associated with access endpoints specified by developers in the request for the campaign at the predetermined data rate. In embodiments, the rate may be zero cost to the clients 320, which may be referred to as “zero-rating.” The operator back end server 410 may cause the free data usage of the app specified by developer 325. Operator back end server 410 may receive information from backend server on apps to zero rate, zero rate URI end points specified by platform back end server 420, and remove zero rating on URI end points specified by platform back end server 420. Operator back end server 410 may also provide app usage and demographic data to platform back end server 420 and/or provide an API for end users to purchase any offered up-sell (which may be provided, for example, by a recommendation application or the application of the app developer 325).

Clients 325 may access data related to the app via a recommendation app provided by the platform recommendation server 415. In an embodiment, data related to the recommendation app may be provided at a predetermined data rate, or even a zero rate.

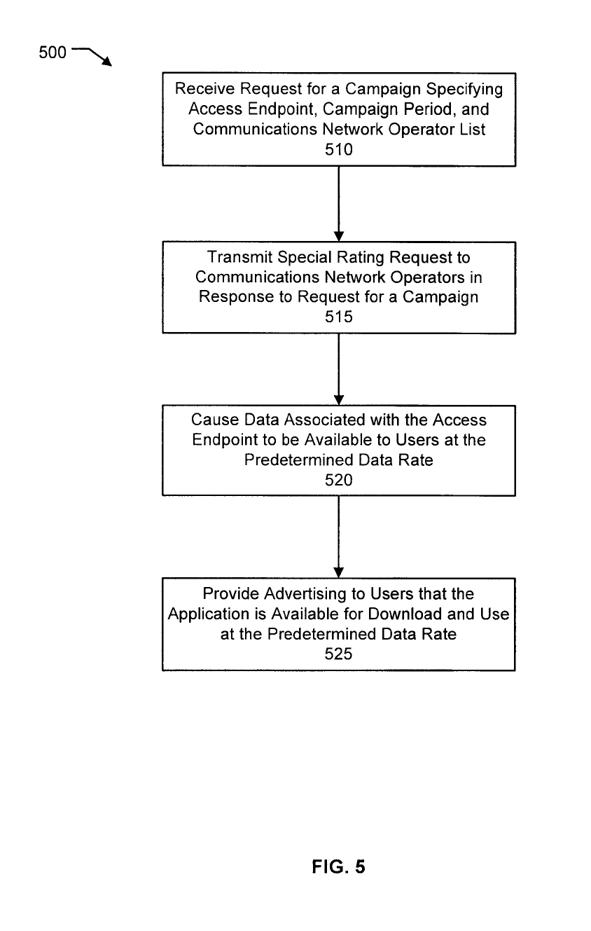

FIG. 5 shows a specific embodiment of a flow diagram for a method 500 for providing mobile applications to users at a predetermined data rate.

At step 510, a request for a campaign may be received at a server, the request including an application title, an access endpoint, a campaign duration, and a communications network operator list of a plurality of communication network operators. The server may be platform server 305 in some embodiments. The request may include one or more access endpoints, each access endpoint being associated with data utilized by the application. The data may be utilized by the application during installation of the application, or during use of the application. The use of the application associated with data from the access endpoints may be all use of the application, or only specified use (e.g., to watch specified media or certain functions of the application). The specified use may be described in the request for the campaign in some embodiments (e.g., specified game modes in a game application, specified geographic locations in a travel application, etc.). Each communications network operator may provide the application having the application title to end users (e.g., clients 320) on a communications network (e.g., mobile data infrastructure 425) operated by the communications network operator. The campaign period is a period of time for which the campaign is active.

In response to receiving the request for the campaign, the server may transmit a special rating request to each communications network operator on the communications network operator list at step 515. The special rating request may include a request to apply a predetermined data rate to data associated with the access endpoint (or set of endpoints) for the campaign period specified by the request for the campaign.

The server may then cause the data associated with the access endpoint to be available at the predetermined data rate on the communications network of one of the communications network operators on the communications network operator list at step 520. The data associated with the access endpoint may be any data related to the application having the application title. Types of data associated with the access endpoint may include installation data for installing the application, and any type of data sent to and from the mobile communication device via the installed application during use of the application. The use may be limited to a portion of the overall data sent and received by the installed application (e.g., only specified content or media may be available at the predetermined data rate, such as video or audio content accessed by the installed application) in some embodiments. Allowing a portion of the data transmitted or received by an application to be available at a zero-rate may be known as partial zero-rating the application. In such embodiments, where a set of access endpoints are to have zero-rated data (or data available at any predetermined data rate less than a standard rate), a subset of the access endpoints, each of the subset being associated with the specified content, may be zero-rated. In other embodiments, all data sent and received by the installed application may be available at the predetermined data rate.

Advertising may be provided by the server to at least one of the end users that the application at step 525. The advertising may communicate that the application is available for download and for use on the communications network of the one of the communications network operators at the predetermined data rate. Advertising may be provided directly by the server (e.g., through the platform application), or the server may indirectly cause advertising to be displayed through conventional online (or off-line) advertising channels.

To provide developers with a method to participate in the zero rating, a developer portal website can be provided where developers can enter the information required for providing data at a predetermined rate (or, in embodiments, zero rating the application). The developer portal website can be built on a popular web framework. The developer portal website can require secure login credentials for each app developer to enter upon entry. The developer portal website can provide multiple views, such as: An “App Description” view that can allow developers to describe their app and/or provide the necessary zero rating information; A “Video Description” and/or “Content Description” view that can allow content producers to describe their video and/or digital content and/or provide the necessary zero rating information. A “Create Zero Rating Promotion” view that can let app marketers configure their promotional campaign for zero rating; and/or A “Completed Promotional Campaigns” view that can showcase the performance of completed promotions and/or provide analytics to help determine an ROI of the promotion and/or campaign.

The App Description view can contain fields to define the app attributes that will be displayed in the discovery app on the clients' device. This can include links to app icon, links to app screen shots, name, and/or description, etc. There can be one or more fields for providing links to the various app stores where the server can scrape for app rating information and/or be used to direct users to the proper install endpoint. There can be fields for providing IP addresses to endpoints the app can access that will be whitelisted for zero rating on the operator networks. App details can be stored in an app database. The Description views can contain fields to define the video and/or content attributes that will be displayed in the discovery app on the clients' device. This can include links to thumbnails, titles, content producers, etc. There can be fields for providing a URI to endpoint containing the digital content. The Create Zero Rating Promotion view can include fields for app marketers to define the promotion period, app to promote, target demographics, and/or target locations, etc. An estimated campaign cost and/or target population number can be generated based on, e.g., the demographic and/or location targets using operator cost metrics. Once submitted, the information can be stored in a campaign database. The Past Zero Rating view can show, for the promotion period, the number of users who installed the app, who used the app and/or how frequently, who already had the app installed, and/or who engaged with the app. A total cost for the campaign can be displayed for ROI analysis.

The Backend Server can provide communication to the client devices, developer portal, and/or operator backend, and/or can provide a Client server for app list requests and/or usage logging. The app, video, and/or content list server can be based off of REST API methodology to process read requests from client devices. Given the specific device and carrier, the campaign database can be queried to determine which apps fit the target device and/or demographic of the user. This list can be collated and/or returned via JSON structure to the requesting device. The server can be asynchronous and/or handle a high volume of incoming requests at a time.

The list of apps can be stored in memory cache for faster retrieval across several servers that respond to incoming requests. Logging can be handled by another set of servers running, for example, Scribe that can retrieve the incoming usage data and/or log the information. The data can be processed (e.g., using Hadoop or similar suitable data processing software) to aggregate the logged data and/or store it in an SQL database. This data can be analyzed to determine app usage and/or content viewing for each user to determine usage behavior and/or user app/content interests. Typical machine learning algorithms, such as boosting algorithms, can analyze how apps perform across a demographic and/or potential apps that a user might engage with. Features for the algorithm can include app category, known user demographic, and/or engagement feedback. This information can be used to score how well each promoted app will likely perform given a user model that can rank the order of apps to display on a given client device. The developer front end portal can store inputs from the app description and/or campaign promotions in databases for the app list generation servers. Campaign performance and/or statistics can be processed from usage logging data and/or aggregated to display on the developer portal. The Backend SQL database can store some and/or all the aggregate usage data, app and/or streaming digital content details, campaign settings, and/or operator settings, etc. A Hadoop map reduce framework can be used to aggregated usage data and/or for machine learning recommendation algorithms. For each app, video, and/or content zero rating campaign, the IP addresses for the app, video, and/or content to whitelist can be transmitted to the operator when the promotion period begins. The operator can send usage metrics and/or billing details to the server. Usage metrics can be saved to the SQL database. Billing details can be sent to the app developer for invoicing and/or transmitted to the operator. Dynamic IP internet traffic can be routed through a proxy server setup for app developers to direct data traffic access requirements to. The proxy server can be used for non-static IP addresses since static IP addresses can directly be whitelisted in the mobile operator's PCRF (Policy charging and rules function) system. The Proxy server's IP address can be whitelisted for zero rating so all traffic that goes through proxy server can be zero rated. The proxy server can perform simple checks to validate that URL accesses are for legitimate zero rated apps by comparing URL access to known zero rated app whitelisting addresses.

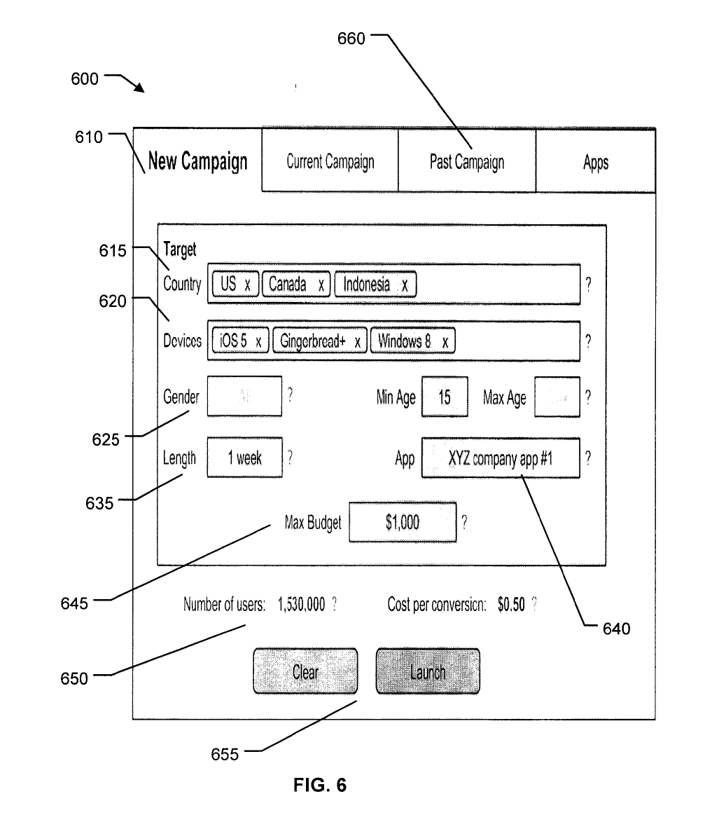

FIG. 6 is a screenshot illustrating configurable settings 600 according to embodiments of a request for a campaign. The app developer may input various settings for a desired campaign in the interface 600. Once the app developer has finished inputting the settings, the data input in interface 600 may be forwarded to the platform server 305 using a request for a campaign. Interface 600 may be provided as part of a developer portal provided by platform front end server 405. As shown, tabs may be provided for an app developer to select, including tabs for a new campaign 610, a current campaign, a past campaign 660, and apps.

Using interface 600, the app developer may input target locations 615 and device types 620 for the desired campaign (to provide app data at a predetermined data rate). Further demographic information for desired users may be provided in boxes 625, including a desired gender and/or age range. At box 635 the app developer may specify the campaign period, the campaign period being the time during which data related to the specified app is available at the predetermined data rate. At box 640, the app developer may provide an application title for the app or apps that are the subject of the campaign.

At box 645, a maximum budget may be provided, which limits the amount the app developer is willing to spend on the campaign. The maximum budget may act as a secondary constraint on the campaign period, meaning that the campaign period may be flexible to terminate before or after the specified campaign period in box 635, depending on whether funds still exist in the maximum budget box 645. At location 655, interactive buttons are provided for the app developer to select whether to clear all of boxes 615, 620, 625, 635, 640 and 645, or to launch a request for the specified campaign.

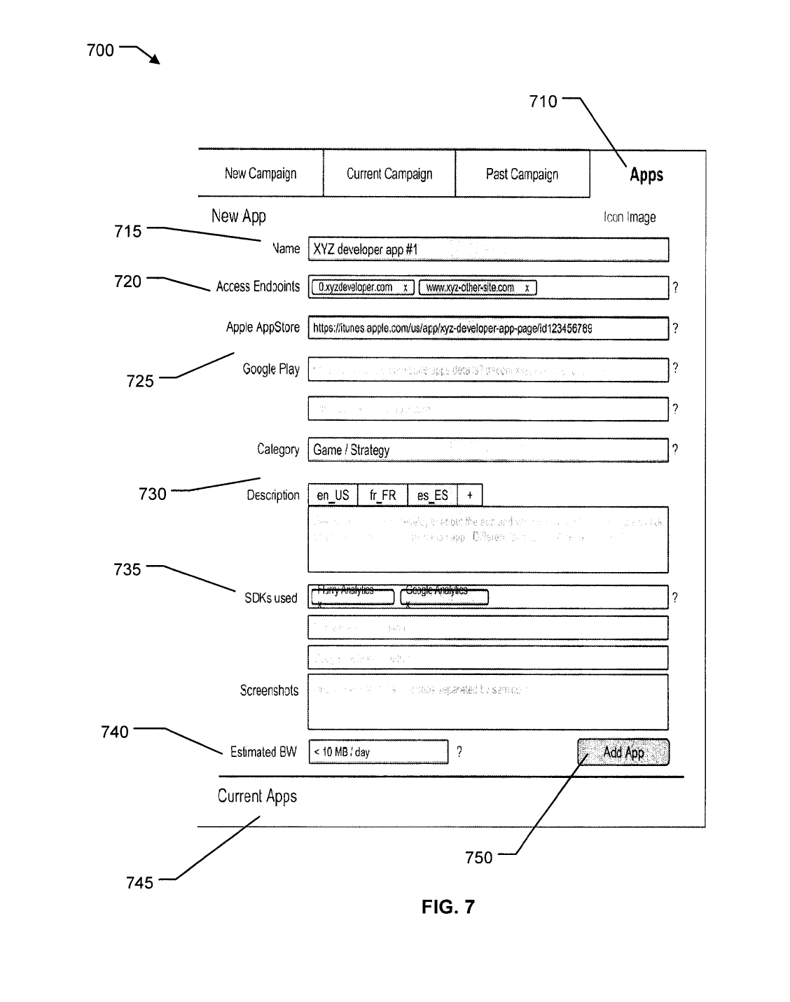

FIG. 7 is a screenshot illustrating configurable settings 700 according to embodiments of an application configuration GUI. Interface 700 may be accessed by selecting an apps tab 710. Interface 700 may be used when an app developer wishes to add an application to a campaign, which may be a new campaign (generated using the interface shown in screenshot 600 to generate a request for a campaign, for example), or an existing campaign.

An app developer may add an application by specifying an application tile in box 715. The developer may also specify one or more access endpoints in box 720, which may provide the data related to the application that will be provided at the predetermined data rate as part of the campaign. Access endpoints may be provided in any suitable domain name format (e.g., URL, IP address, etc). Box 725 may provide a link to the app's webpage in an app store, such as the Apple AppStore provided by Apple, Inc. of Cupertino, Calif. At area 730 of screenshot 700 is an area where the app developer may describe the app. The description may include a genre classification of the app (e.g., game, reference, productivity, etc.) and a narrative for the application in different languages.

At area 735, the app developer may provide a list of software development kits (“SDKs”) that are used and installed into their application so the platform server can determine how sponsored data (i.e., data provided by the access endpoints) will be applied to those SDKs. These SDKs may perform background data accesses which need to be prevented or sponsored so app users have the same predetermined data rate on those data accesses. An example of one of these SDKs may be Flurry© which provides an SDK to app developers that collect and log data to their backend servers to track user activity in the developer's app and then provides that feedback to developers in an aggregated form.

Box 740 may allow app developers to estimate the average rate of data consumed by users who use the application in a given time period as a way to inform operators of the expected traffic that the predetermined data rate will apply. Mobile operators may charge app developers a fixed cost based on this estimated average data usage instead of a cost based on actual data consumed.

Once the app developer has finished entering the app settings for the campaign, the app developer may add the app to the request for the campaign by actuating button 750. A list of current apps on the campaign may be listed in region 745 of screenshot 700.

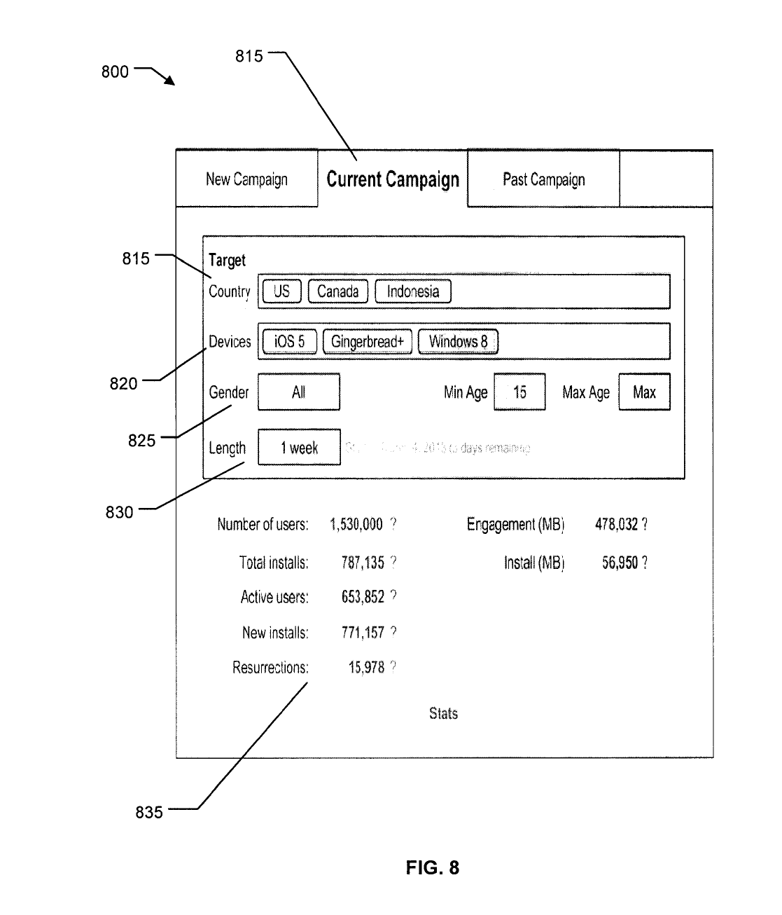

FIG. 8 is a screenshot illustrating configurable settings 800 according to embodiments of an existing campaign. The interface shown in screenshot 800 may be accessed by actuating current campaign tab 815. Interface 800 may show app developers the progress of the requested campaign during the campaign period, and allow the app developer to modify the campaign during the campaign. This may be done, for example, in response to analytic data generated during the campaign.

The campaign target audience of users may be adjusted using interface 800. Using interface 800, the app developer may adjust target locations 815 and device types 820 for the desired campaign (to provide app data at a predetermined data rate). Further demographic information for desired users may be adjusted in boxes 825, including a desired gender and/or age range. At box 830 the app developer may alter the campaign period. For the app developers convenience, the start date of the campaign may be provided, as well as the number of remaining days, to help the app developer tailor the campaign to the developer's needs.

Analytics may be provided in region 835 of interface 800. As shown, such analytics may include data such as the lifetime number of users for the campaign period, number of installs, number of active users, number of new installs, resurrections (i.e., users who reactivated the app during the application period after removing the app from their device), the engagement of the app (i.e., the amount of data consumed by users during the campaign period) and the amount of data consumed for installation.

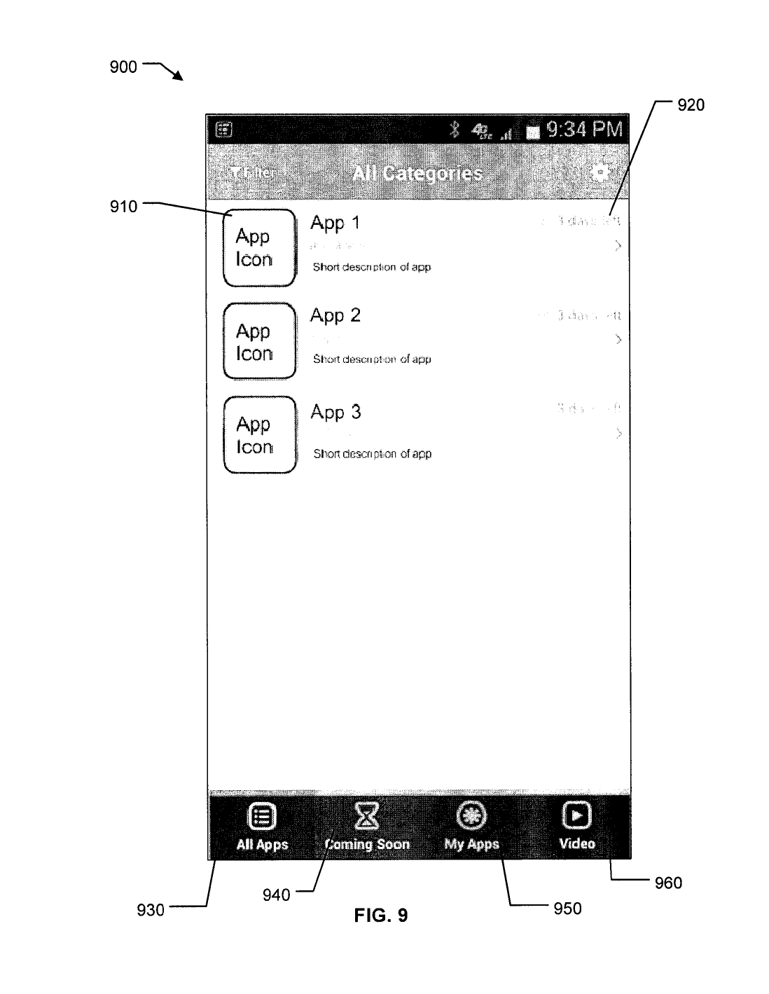

The platform application can provide an interface for the end user and/or can provide a mechanism for an end user to discover promoted apps. FIG. 9 is a screenshot illustrating configurable settings 900 according to embodiments of the platform application. The platform application can provide a web interface for mobile devices such as those running iOS, Android, Symbian, Blackberry 10, Tizen, Firefox OS, Ubuntu Touch OS, Windows RT, and/or Windows Phone, etc. A web service can provide an interface for the platform application to access the backend server's app promotion data. The web interface can be developed in any common web framework. The web interface can receive requests from the platform application and/or can provide a list of apps and digital streaming content available at the predetermined data rate for a target carrier, device, and/or user demographic. The list of apps can be retrieved from a server running a web service that maintains a list of apps to zero rate. The user may interact with the list of apps available at the predetermined data rate to view app details and/or can be provided a link to download the app. The platform application can also track app installs, provide notifications regarding the free data period, and/or provide an up-sell mechanism to sell products related to the application.

The platform application can contain multiple views, such as: An “All Apps” view may be shown in response to selecting all apps tab 930, and can show apps that are currently zero rated. A “Coming Soon” view may be shown in response to selecting coming soon tab 930, and can shows apps that are scheduled to be zero rated. A “My Apps” view may be shown in response to selecting my apps tab 950, and can show apps that a subscriber has installed that are zero rated. A “Videos” view, which may be shown in response to selecting video tab 960, can, for example, show digital streaming video content that a subscriber can stream from the platform application that are zero rated. Similarly, a “Streams” view, which may be shown in response to selecting a streams tab (not shown), can show streaming digital content that a subscriber can stream that is zero rated. The video content may be stored on the platform server, or on an access endpoint (or set of endpoints) external to the platform server, the external access endpoint being associated with a campaign to zero rate the video content.

The app views can be list views that can include, e.g., an app icon 910, the app name, a star rating of the app, and/or how many days of data available at a predetermined rate 920. The videos views and/or stream views can include, e.g., a content thumbnail, content title, and/or content producer, etc. The app views can be filtered by different app categories (ie. games, traveling, etc.). The video views and/or stream views can be filtered by different content categories. Selecting an app can open a new window showing details of the app with the same information as the list view, a detailed description of the app, and/or screen shots. An install icon, which can direct a user to the relevant app store on app promotion effectiveness e(s), can be provided on this window. Selecting streaming content will stream that content and playback that content on the user device.

The list of apps, videos, and/or steaming content to display in the views can be retrieved from a central server through an HTTPS request that includes the device ID and/or carrier name. The server can return the app, video, and/or streaming content description fields and/or links to the icon and/or screen shots. Each app can have promotion start and/or end dates that can be used to determine if they are in the All Apps or Coming Soon views. Each app can have an app store link to install the app. The app can download the icons and/or screen shots from the URI endpoint when required and/or cache them on the client device. The list of apps, videos, and/or streams can be cached on the client device and/or updated periodically, such as once a day, with new items from the central server. Every interaction with the app can be logged and/or the activity list can be uploaded to the central server to analyze usage patterns. The user can be alerted through the device's notification system when zero rating, on an app that user installed, is about to expire and/or further use will incur data costs. At this time, certain exemplary embodiments can upsell the users on the operator's data plans by allowing users to purchase a data plan right in the application.

Certain specific embodiments can learn from subscribers' usage patterns by tracking app install and engagement and/or dynamically promote apps in the Lotus Flare Application that they are likely to engage more with. The platform application can target, rank, and/or recommend apps based on the user's app usage and/or engagement patterns using data collected by an analytics logging service, such as the SDKs described herein.

Because of the high cost of data roaming, consumers often are reluctant to use apps while roaming. Certain specific embodiments can allow consumers to buy data packages for unlimited roaming data use on the app, effective for a set duration of time on a per app basis.

The platform provided by platform server 305 to provide applications at a predetermined data rate can provide a mechanism for app developers to offer and/or provide special rate apps for subscribers who are roaming outside of their home network. The platform can provide a mechanism for operators to offer data packages at special rate to subscribers for a set of apps while roaming outside of their home network. Also, the platform application may discover special rated apps anytime and anywhere. For example, the list of apps in the platform application may change depending on location, time and user's profile.

App developers often need to promote and/or market their apps. One of the main channels they tend to use is display ads. Display ads typically are charged by impressions, whereas certain exemplary embodiments can charge by conversion and/or engagement for better return on investment for developers. Display ads typically interrupt user experience, whereas certain exemplary embodiments can offer a more satisfying user experience by reducing data friction. Reduced data friction means that users do not have to worry about data charges when they use apps available at the predetermined rate, such as zero-rated apps.

A further feature that may be possible using the platform server may be “contextual upselling” of data to end users. An application may be able to detect, using a platform software development kit described in greater detail below, when a campaign that includes zero-rating (or providing data from access points at a predetermined data rate) is going to end, or an existing data package is nearly finished (either the user's monthly allotment, or a pre-paid data plan, such as data plans used for travel), or if the end user is accessing a non-zero-rated network. In such situations, the end user may be exposed to paying expensive roaming fees for continued data access, and access to data associated with the access endpoint at the predetermined data rate by the mobile communications device will be ended at a predetermined time. The predetermined time may be a time and date (e.g., of a campaign expiration), or a data limit (e.g., the end user's monthly limit, or a predetermined amount of data). Accordingly, when the application (provided by the application developer) detects a situation where the end-user will no longer be utilizing the predetermined data rate for data consumption, the application may provide an upsell message to the end user (via pop-up message, or redirection to a predetermined web address). The upsell message may inform the end user that future data consumption will not be zero-rated, and may provide the opportunity to purchase additional data from the end user's mobile operator.

For example, in response to determining that the user's prepaid 1 gigabyte of data has almost completely been used (e.g., a threshold data remains, such as 50 megabytes), the application may provide an upsell message to the end user via the mobile communications device browser. The upsell message may inform the end user that he or she may purchase 200 additional megabytes, to avoid costly roaming charges, and may also provide a web link for the end user to select and facilitate the purchase of additional data. The additional data amount may be provided directly via the mobile operator, or may be provided via the platform server, through a preexisting agreement with the mobile operator. The upsell message may, when the user's data access at the predetermined rate expires, be displayed on a screen of the mobile communications device, instead of an error message as is conventionally displayed when a device lacks data access. In some embodiments, at least a portion of revenue generated by end user purchases of data by the upsell message and associated links may be given to the application developer, as an incentive for including the upsell functionality in the application (e.g., using the platform software development kit and selecting an option permitting contextual upselling of data). Contextual upselling in the manner described may provide a better marketing experience for mobile operators in their data package sales, since offers to purchase data may be provided to users at the time the users need to purchase data to avoid roaming charges.

In addition to the platform app SMS messages may be used to promote zero-rated apps. Furthermore, conventional display ad channels (e.g., using search engines, or advertisements on web sites) may be used to promote zero-rated apps, or apps available at a predetermined data rate.

The Operator zero rating process can utilize an API built in their backend that communicates with the Lotus Flare operator interface server. This API can update the Policy Charging and/or Rules Function to whitelist the IP addresses submitted from Lotus Flare server. The API can query and/or transmit the usage metrics for each subscriber to the Lotus Flare server. The API can be built in partnership with participating operators to update their PCRF based on their unique system infrastructure. For operators without PCRF systems, the API can update legacy IP whitelisting systems based on the system specification. Communications between the API and Lotus Flare servers can use highly secure and encrypted internet protocols. The API interface can be standard across all operators with only IP whitelisting procedures uniquely defined for different operator backend technologies employed.

In various embodiments, app developers may dynamically negotiate cost of mobile data with mobile operators so that end users don't have to pay for mobile data while using their apps. Also, mobile operator, based on load on its network, may charge differentiated pricing to app developers to run campaigns with predetermined data rates (e.g., zero rating, or a fixed cost lower than the normal data rate for the users). For example, at night when the network utilization is low, a mobile operator can charge lower cost for the mobile data to app developers, versus during the day time when the network utilization tends to be higher.

Also, the platform server can optimize for maximum conversion by matching app developers to a preferred or optimal user profile. As an example, a user who travels frequently may be more valuable to a travel app developer than a lifestyle or a game developer. The platform server can work with the mobile operator to access user behavior data aggregated by the mobile operator to improve targeted campaigns. For example a travel app developer would like to target a list of travel-heavy users instead of a list of all users of the mobile operator's network during the campaign period. The platform server may identify the list of preferred users (e.g., frequent travelers) and offer access to the list of preferred users to the application developer at a different price or rate than the list of all users of the mobile operator's network during the campaign period. Such targeted campaigns may be more effective and cost-efficient to the application developer than a campaign available to all users of the mobile operator's network.

In order for the platform server to provide application data at a predetermined rate, there are several exemplary embodiments. First, the platform server may utilize a proprietary platform software development kit (“SDK”) integrated with the application. Alternatively, a virtual private network (VPN) may be installed on mobile communication devices, where the VPN may be used to communicate with the platform server. In a third embodiment, an access application may be utilized, where the access application provides a sponsored data web view to a mobile web of participating app and content providers.

Regarding the first embodiment, the platform SDK may be integrated into a participating campaign application. The SDK may provide several features, including one or more of: custom interface for data accesses, user notifications, and analytical logging. With custom interfaces for data accesses to such interfaces as HTTP, HTTPS and streaming media, the SDK may perform all necessary operations to provide the zero rated access (or access at a predetermined data rate). User notifications may inform users when they are in the predetermined data rate access and when the predetermined data rate access will end. Analytical logging may be used by the SDK to provide usage information and user activity levels.

In the second embodiment, a user on a sponsored data network may install a VPN service on their mobile communication device. The VPN service may direct all data traffic from zero rated apps to special endpoints designated by the platform server. The special endpoints designated by the platform server may be allowed to transmit and receive data at the predetermined data rate on the corresponding mobile operator network, thereby providing access at the predetermined data rate.

In the third embodiment, an access application may be installed on the client device that accesses a mobile web view of an app or steaming content. Data associated with the mobile web view may originate from the app developer server, content provider server or from the platform server. The data access loaded into the web view will be sponsored, meaning that data associated with the mobile web view is available to users at the predetermined data rate during the campaign period.

In the description above and throughout, numerous specific details are set forth in order to provide a thorough understanding of the disclosure. It will be evident, however, to one of ordinary skill in the art, that the disclosure may be practiced without these specific details. In other instances, well-known structures and devices are shown in block diagram form to facilitate explanation. The description of the preferred an embodiment is not intended to limit the scope of the claims appended hereto. Further, in the methods disclosed herein, various steps are disclosed illustrating some of the functions of the disclosure. One will appreciate that these steps are merely exemplary and are not meant to be limiting in any way. Other steps and functions may be contemplated without departing from this disclosure.

What is claimed is:

1. A method comprising:
receiving, by a server, a request for a campaign, the request including an application title, an access endpoint, a campaign period, and a communications network operator list of a plurality of communication network operators, each communications network operator providing the application having the application title to end users on a communications network operated by the communications network operator, the campaign period being a period of time;
in response to receiving the request for the campaign, transmitting, by the server, a special rating request to each communications network operator on the communications network operator list, the special rating request including a request to apply a predetermined data rate to data associated with the access endpoint for the campaign period specified by the request for the campaign;
causing, by the server, the data associated with the access endpoint to be available at the predetermined data rate on the communications network of one of the communications network operators on the communications network operator list; and
providing advertising, by the server, to at least one of the end users that the application is available for download and for use on the communications network of the one of the communications network operators at the predetermined data rate.

2. The method of claim 1, the request for a campaign further including a specified location, the special rating request further including a request to apply the predetermined data rate to end users accessing data in the specified location, the data associated with the access endpoint being available in response to the special rating request at the specified location at the predetermined data rate, the advertising further including reference to the specified location as having the application available at the predetermined data rate.

3. The method of claim 2, the specified location being any location outside of an end user's home network.

4. The method of claim 1, the request for a campaign further including a specified end user group, the special rating request further including a request to apply the predetermined data rate to end users belonging to the specified end user group, the data associated with the access endpoint being available in response to the special rating request at the predetermined data rate to the end users belonging to the specified end user group, the advertising further including reference to the end users belonging to the specified end user group as having the application available at the predetermined data rate.

5. The method of claim 1, the special rating request further including a data threshold amount, the method further comprising causing the data associated with the access endpoint to revert from the predetermined data rate to an operator-specified rate on the communications network of one of the communications network operators on the communications network operator list when an amount data retrieved from the access endpoint exceeds the data threshold amount.

6. The method of claim 1, the advertising being provided to the at least one of the end users via a platform application, the platform application including a list of a plurality of applications available at predetermined rates for the end user to download.

7. The method of claim 1 where the predetermined data rate is zero charge to the end user.

8. The method of claim 1, the request for the campaign further comprising a set of access endpoints, the special rating request including a request to apply the predetermined data rate to data associated with the set of access endpoints for the campaign period specified by the request for the campaign, the server causing the data associated with the set of access endpoints to be available at the predetermined data rate on the communications network of one of the communications network operators on the communications network operator list.

9. The method of claim 1, the method further comprising:
causing, by the server, data associated with the access endpoint to be provided to a mobile communications device at the predetermined data rate;
determining, by the server, that access to data associated with the access endpoint at the predetermined data rate by the mobile communications device will be ended at a predetermined time; and
causing, by the server, an upsell message to be displayed on the mobile communications device, the upsell message including a message that future data consumption will not be at the predetermined data rate and the upsell message including an opportunity to purchase additional data.

10. A system comprising:
a server communicatively coupled to a network, the server executing instructions stored in memory to:
receive a request for a campaign via the network, the request including an application title, an access endpoint, a campaign period, and a communications network operator list of a plurality of communication network operators, each communications network operator providing the application having the application title to end users on a communications network operated by the communications network operator, the campaign period being a period of time;
in response to receiving the request for the campaign, transmit a special rating request via the network to each communications network operator on the communications network operator list, the special rating request including a request to apply a predetermined data rate to data associated with the access endpoint for the campaign period specified by the request for the campaign;
cause the data associated with the access endpoint to be available to the end users at the predetermined data rate on the communications network of one of the communications network operators on the communications network operator list; and
provide advertising, via the network, to at least one of the end users that the application is available for download and for use on the communications network of the one of the communications network operators at the predetermined data rate.

11. The system of claim 10, the server further executing instructions stored in memory to provide analytics to an application developer, the analytics including information regarding consumption of the data associated with the access endpoint during the campaign period.

12. The system of claim 11, the server further executing instructions stored in memory to receive the analytics from the one of the communications network operators that offers the data associated with the access endpoint to be available to the end users at the predetermined rate.

13. The system of claim 10, the advertising being provided to the at least one of the end users using a platform application, the server further executing instructions stored in memory to: receive a end user selection of the application from the platform application over the network; and provide advertising content related to the application to the end user via the platform application.

14. The system of claim 13 wherein the advertising content includes additional applications related to the subject matter of the application.

15. The system of claim 13, the request for a campaign further including a specified location, the special rating request further including a request to apply the predetermined data rate to end users accessing data in the specified location, the data associated with the access endpoint being available in response to the special rating request at the specified location at the predetermined data rate, the advertising further including reference to the specified location as having the application available at the predetermined data rate.

16. The system of claim 10 the server further executing instructions stored in memory to notify the end user when the campaign period expires.

17. A non-transitory computer readable storage medium having embodied thereon a program, the program being executable by a processor for performing a method for enhancing a signal, the method comprising:
receiving, by a server, a request for a campaign, the request including an application title, an access endpoint, a campaign period, and a communications network operator list of a plurality of communication network operators, each communications network operator providing the application having the application title to end users on a communications network operated by the communications network operator, the campaign period being a period of time;
in response to receiving the request for the campaign, transmitting, by the server, a special rating request to each communications network operator on the communications network operator list, the special rating request including a request to apply a predetermined data rate to data associated with the access endpoint for the campaign period specified by the request for the campaign;
causing, by the server, the data associated with the access endpoint to be available at the predetermined data rate on the communications network of one of the communications network operators on the communications network operator list; and
providing advertising, by the server, to at least one of the end users that the application is available for download and for use on the communications network of the one of the communications network operators at the predetermined data rate.

18. The non-transitory computer readable storage medium of claim 17, the method further comprising automatically reverting a data rate associated with data associated with the access endpoint to an operator-specified rate in response to the campaign period expiring.

19. The non-transitory computer readable storage medium of claim 18, the method further comprising aggregating a summary of data usage for data associated with the access endpoint during the campaign period, and providing the summary of data usage to a developer of the application in response to the campaign period expiring.
